(19) United States
(12) Patent Application Publication
(10) Pub. No.: US 2026/0365456 A1
(43) Pub. Date: Nov. 19, 2026

(54) Work Support System

(71) Applicant: Daifuku Co., Ltd., Osaka-shi (JP)

(72) Inventors: Wataru Kiyokawa, Tokyo (JP); Atsushi Minoo, Tokyo (JP); Masaya Miyamoto, Tokyo (JP)

(21) Appl. No.: 19/515,830

(22) PCT Filed: Jun. 12, 2024
(86) PCT No.: PCT/JP2024/021325

§ 371 Date: Mar. 3, 2026

(30) Foreign Application Priority Data
Sep. 4, 2023 (JP) 2023-142819

(51) Int. Cl. B65G 57/03

(52) U.S. Cl. CPC B65G 57/03

(57) ABSTRACT

A work support system supports, with an instruction to an operator, the operator in loading a plurality of articles onto a base for receiving the plurality of articles. The work support system includes a projector and a controller that controls the projector. The controller causes the projector to project, onto a projection-receiving object, a position indication of a position at which a target article is to be loaded. The projection-receiving object is at least one of the base or an article loaded on the base.

### CROSS-REFERENCE TO RELATED APPLICATIONS

This application is the United States national phase of International Patent Application No. PCT/JP2024/021325 filed Jun. 12, 2024, and claims priority to Japanese Patent Application No. 2023-142819 filed Sep. 4, 2023, the disclosures of which are hereby incorporated by reference in their entireties.

### BACKGROUND OF THE INVENTION

### Field of the Invention

The present disclosure relates to a work support system that supports, with an instruction to an operator, the operator in loading multiple articles onto a base that can receive the articles.

### Description of Related Art

An example of such a work support system is described in Japanese Patent No. 6074769. In the background described hereafter, reference signs and names in parentheses are the reference signs and the names in Japanese Patent No. 6074769 “(JP 6074769”).

A loading facility in JP 6074769 includes a transferrer (transfer robot 4) that loads articles onto a mounting portion (mount 8) and a controller (H) that controls the operation of the transferrer (4). The transferrer (4) loads the articles onto a loading receiver (cage cart 3), which includes the mounting portion (8), a back surface, and a pair of side surfaces. The mounting portion (8) is quadrangular in a plan view and receives and supports the articles. The back surface and the pair of side surfaces extend upward from three sides of the four sides defining the outer edge of the mounting portion (8). The transferrer (4) loads the articles onto the loading receiver (cage cart 3) in an arrangement determined with an arrangement determination method for determining an arrangement to load articles in multiple layers. When, for example, the transferrer (4) cannot be used due to, for example, a limited installation space or a failure, an image showing a determined loading pattern may be displayed on a monitor and an operator may manually load articles (W) onto the loading receiver (3) based on the image displayed on the monitor.

When loading multiple articles, the operator may not intuitively determine a specific position at which each article is to be loaded only with the image displayed on the monitor, and may thus make a mistake in the operation. Such a mistake in the operation may not allow an article to be loaded based on the determined loading pattern, and thus may not allow all the articles to be loaded onto the loading receiver.

### SUMMARY OF THE INEVNTION

One or more aspects described herein are directed to a work support system that allows an operator to easily identify the position to load a target article.

In response to the above discussed problem, a work support system is a work support system for supporting, with an instruction to an operator, the operator in loading a plurality of articles onto a base for receiving the plurality of articles. The work support system includes a projector, and a controller that controls the projector, the controller being configured to cause the projector to project, onto a projection-receiving object, a position indication of a position at which a target article is to be loaded. The target article is an article, among the plurality of articles, to be loaded onto the base or onto an article, among the plurality of articles, loaded on the base. The projection-receiving object is at least one of the base or the article loaded on the base.

In this structure, the operator can easily identify the position to load the target article by viewing the position indication projected onto the projection-receiving object when loading multiple articles onto the base. The operator can thus load the articles more efficiently.

### BRIEF DESCRIPTION OF THE DRAWINGS

FIG. 1 is a schematic diagram of an article transport facility.

FIG. 2 is a perspective view of a cage cart.

FIG. 3 is a perspective view of the cage cart during loading.

FIG. 4 is a control block diagram.

FIG. 5 is a diagram describing a work support system according to a first embodiment.

FIG. 6 is a diagram describing a work support system according to a second embodiment.

FIG. 7 is a diagram describing a work support system according to a third embodiment.

FIG. 8 is a diagram describing a work support system according to a fourth embodiment.

FIG. 9 is a diagram describing a work support system according to a fifth embodiment.

FIG. 10 is a diagram describing a work support system according to a sixth embodiment.

FIG. 11 is a diagram describing a work support system according to a modification of the sixth embodiment.

FIG. 12 is a diagram describing a work support system according to a modification of the sixth embodiment.

FIG. 13 is a diagram describing a work support system according to a modification of the second embodiment.

### DESCRIPTION OF THE INVENTION

### 1. First Embodiment

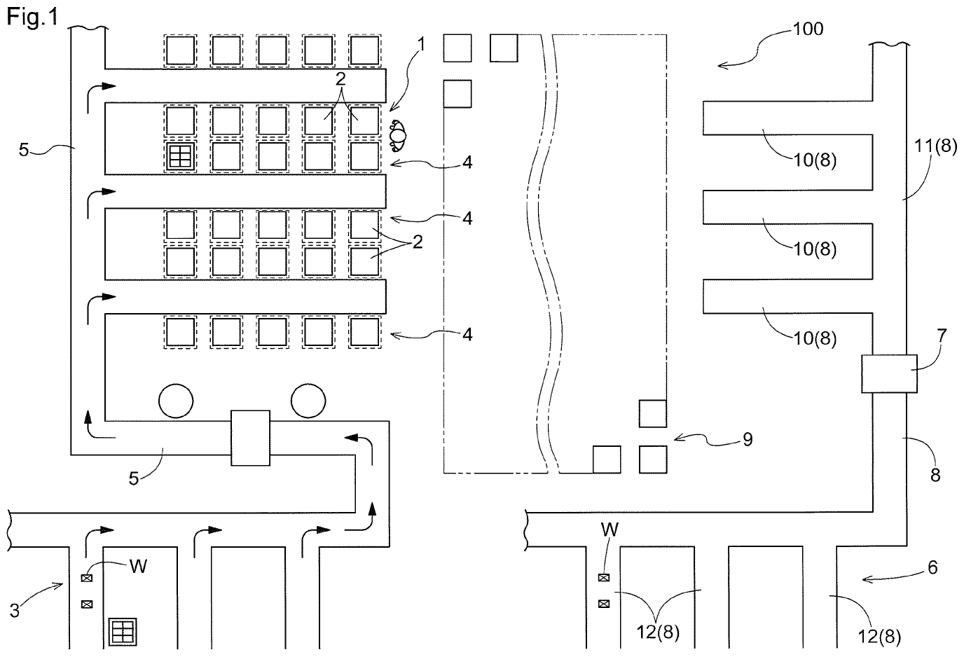

A work support system 1 according to a first embodiment will be described with reference to the drawings. The work support system 1 used in an article transport facility 100 in an example will be described below with reference to the drawings. In the present embodiment, as shown in FIG. 1, the article transport facility 100 includes the work support system 1, an infeeder 3 into which articles W are brought, a transport conveyor 5, work areas 4, a storage 9 that stores the articles W, a shipping conveyor 8, a labeling machine 7 adjacent to the shipping conveyor 8, and a shipping area 6.

Incoming articles W to the article transport facility 100 are loaded onto bases (cage carts 2 in this example) using the work support system 1. The articles W loaded on the bases (cage carts 2) are stored into the storage 9. Articles W to be shipped from the article transport facility 100 are placed onto the shipping conveyor 8 from the storage 9. The articles W are then transported to the shipping area 6 by the shipping conveyor 8, and shipped out of the article transport facility 100 through the shipping area 6. The articles W to be shipped are labeled by the labeling machine 7 while being transported by the shipping conveyor 8. The articles W that have arrived at the shipping area 6 are loaded onto, for example, trucks and transported to their destinations.

The articles W loaded onto the bases (cage carts 2) using the work support system 1 may be directly transported to the shipping area 6 by the shipping conveyor 8 without being stored into the storage 9. The articles W may be directly transported to the shipping area 6 for shipment, without being placed onto the shipping conveyor 8. In this case, the articles W are not labeled by the labeling machine 7.

In the example in FIG. 1, the shipping conveyor 8 includes first outfeed conveyors 10, a second outfeed conveyor 11, and third outfeed conveyors 12. The first outfeed conveyors 10 are arranged adjacent to the storage 9. Each of the multiple first outfeed conveyors 10 has a downstream side connected to the second outfeed conveyor 11. The labeling machine 7 is located adjacent to the second outfeed conveyor 11. The second outfeed conveyor 11 is connected to the multiple third outfeed conveyors 12 downstream from the labeling machine 7. Each of the multiple third outfeed conveyors 12 overlaps the shipping area 6 when viewed vertically. In other words, articles W placed on the first outfeed conveyors 10 pass through the second outfeed conveyor 11 and are each transported to one of the multiple third outfeed conveyors 12. In the shipping area 6, an operator unloads each article W from the corresponding third outfeed conveyor 12, and loads the article W onto, for example, a cage cart 2.

Examples of the bases include various containers, such as pallets, cartons, and foldable containers, and dollies, in addition to the cage carts 2. A vehicle such as a truck can stop in the shipping area 6. Multiple loaded articles W are transferred to the vehicle and shipped. In the example in FIG. 1, the labeling machine 7 is a labeler that automatically attaches a label indicating a destination to each article W. The structure of the shipping conveyor 8 may be changed as appropriate.

The storage 9 stores the multiple articles W loaded onto the bases (cage carts 2) with the work support system 1. In the example in FIG. 1, multiple bases (cage carts 2) are arranged in the storage 9, and multiple articles W are loaded on each base (cage cart 2). The storage 9 is located between the work support system 1 and the shipping conveyor 8 (the first outfeed conveyors 10 in this example). In other words, the storage 9 is adjacent to the work support system 1 and the shipping conveyor 8. To transport articles W loaded or not loaded on a base (cage cart 2) without using the conveyors in the article transport facility 100, for example, a forklift or an automated guided vehicle (AGV) may be used in addition to manual transport.

In the present embodiment, the articles W are containers stackable on the bases (cage carts 2). For example, the articles W are cardboard boxes serving as cartons containing items. Examples of the items contained in the cartons include clothes, books, drinking water, foods, and machine parts.

The articles W are not limited to articles W of one type, and may be articles W of multiple types. The articles W of the same type refer to articles W being all the same in size (length, width, and height), shape, and weight. The articles W of different types are defined as articles W being all or partly different in size, shape, and weight.

The work support system 1 is a device that supports, with an instruction to an operator, the operator in loading multiple articles W onto a base (cage cart 2) that can receive the articles W.

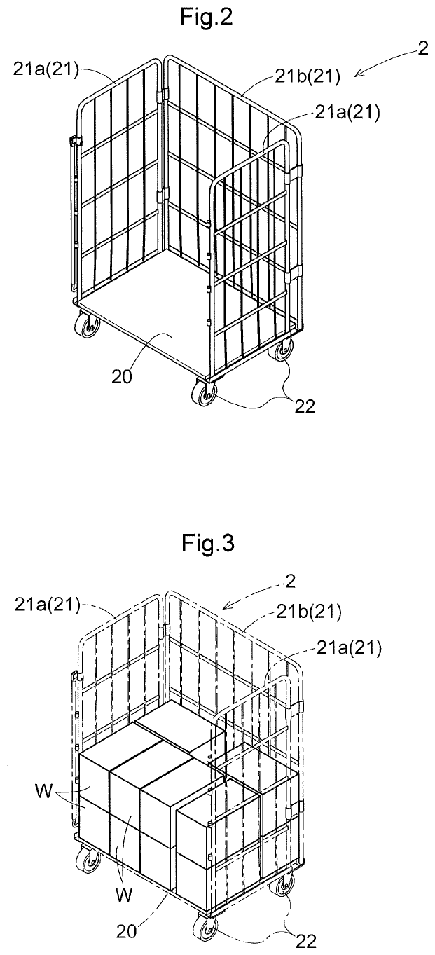

As shown in FIG. 2, each cage cart 2 in the present embodiment includes a mount 20 that is quadrangular in a plan view and receives and supports articles W, three peripheral walls 21 extending upward from three sides of the four sides defining the outer edge of the mount 20, and multiple wheels 22 for mobility on the lower surface of the mount 20. Two peripheral walls 21 facing each other of the three peripheral walls 21 are each referred to as a side surface 21a, and the remaining peripheral wall 21 is referred to as a back surface 21b. The direction in which the pair of side surfaces 21a are aligned is referred to as the lateral direction, and the horizontal direction perpendicular to the lateral direction is referred to as the front-rear direction.

As shown in FIG. 3, articles W are first loaded onto the mount 20 of the cage cart 2, and additional articles W are sequentially loaded onto the articles W that have been loaded.

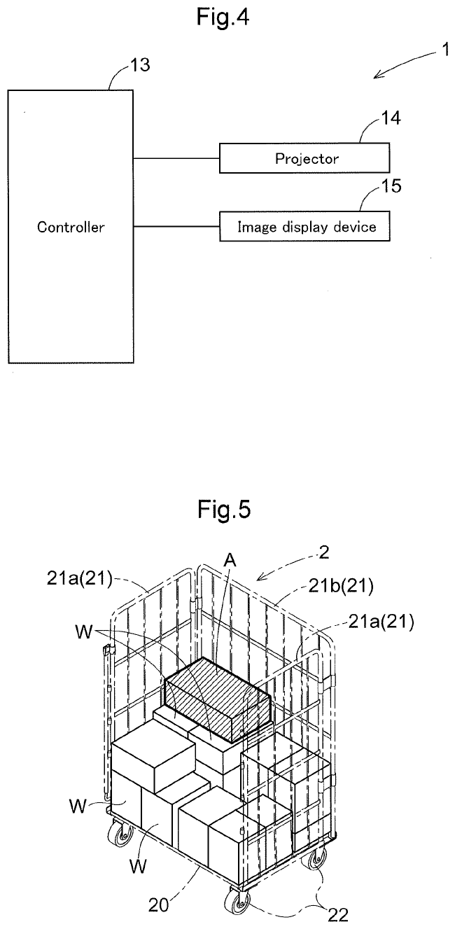

In the present embodiment, the work support system 1 includes a projector 14 and a controller 13 that controls the projector 14 as shown in FIG. 4.

Article information about, for example, the sizes (lengths, widths, and heights), the shapes, the weights, and the number of articles W is input into the controller 13. The controller 13 determines a loading arrangement pattern for loading the multiple articles W onto a cage cart 2 based on a predetermined criterion, and stores the loading arrangement pattern.

The work support system 1 is activated when an operator unloads an article W from the transport conveyor 5 to load the article W onto a cage cart 2 in a work area 4. The controller 13 then controls the projector 14 to project, onto a projection-receiving object, a position indication A of a position at which a target article is to be loaded based on the loading arrangement pattern. The projection-receiving object is at least one of the base (cage cart 2) or one or more articles W already loaded on the base (cage cart 2). The target article is an article W to be loaded onto the base (cage cart 2) or one or more articles W already loaded on the base (cage cart 2). In the present embodiment, as shown in FIG. 5, the position indication A of the position at which the target article is to be loaded is projected onto one or more articles W already loaded on the cage cart 2 as the projection-receiving object, using mixed reality (MR) implemented through goggles worn by the operator.

The operator can thus easily identify the position to load the target article by viewing the position indication A projected onto the projection-receiving object when loading multiple articles W onto the base (cage cart 2). The operator can thus load the articles W more efficiently.

The projector 14 that can be used in one or more embodiments of the present invention is not limited to MR. Other examples include a laser pointer and projection mapping. In other words, projection is not limited to projecting an image onto a base (cage cart 2) or one or more articles W in an overlapping manner with, for example, MR goggles as in the present embodiment, and includes projecting an image directly onto a base (cage cart 2) or one or more articles W.

In the present embodiment, the projection-receiving object is one or more articles W to be located below the target article and serve as a receiving surface for the target article. In some embodiments, the projection-receiving object may be the base (e.g., the mount 20 of the cage cart 2) that serves as the receiving surface for the target article. Further, the projection-receiving object may be, in addition to the base serving as the receiving surface or one or more articles W to be located below the target article and serve as the receiving surface, a sidewall surface (e.g., a peripheral wall 21 of the cage cart 2) of the base on which the target article is to be loaded or side surfaces of one or more articles W to be located in the same layer as the target article. Projection may not be performed on the receiving surface, and only the sidewall surface (e.g., a peripheral wall 21 of the cage cart 2) may serve as the projection-receiving object. In other words, the position indication is not limited to an indication projected onto the position at which the target article is to be loaded as in the present embodiment, and includes an indication projected onto a portion near the position at which the target article is to be loaded to indicate the loading position.

The position indication may be, for example, a point or an arrow (e.g., an arrow projected onto the sidewall surface of the base on which the target article is to be loaded) to simply indicate the position at which the target article is to be loaded.

In the above embodiment, the articles W are loaded only by the operator, rather than by a transfer robot. However, the embodiments are not limited to this example. In some embodiments, for example, the operator may perform loading in place of a transfer robot during, for example, a restoration operation performed when the transfer robot has a failure and an error occurs in the loading or a maintenance operation of the transfer robot.

### 2. Second Embodiment

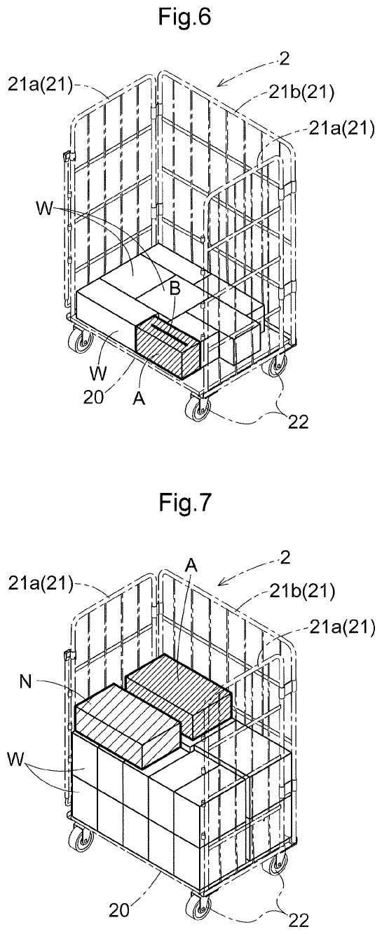

A work support system 1 according to a second embodiment will now be described with reference to FIG. 6. In the present embodiment, each article W is rectangular in a plan view. The present embodiment differs from the first embodiment in that the controller 13 causes a direction indication B of the direction in which the long sides of the target article in a plan view are to be aligned to be projected onto the projection-receiving object, in addition to or together with the position indication A. The work support system 1 according to the present embodiment will be described below focusing on the differences from the first embodiment. The components and the structures not described below are the same as those in the first embodiment.

Being rectangular in the present embodiment may not refer to being precisely rectangular, and may refer to being roughly rectangular in shape.

In the present embodiment, the position indication A and the direction indication B are integrated and represented as a single image. The position indication A is rectangular, and the direction indication B is linear. The direction indication B is to be represented in a color (e.g., red) easily viewable by the operator. The position and the orientation to load each rectangular article W are indicated at the same time by the position of the position indication A and the orientation of the direction indication B.

In this structure, when loading each article W that is rectangular in a plan view, the operator can easily identify the direction in which the long sides of the article W in a plan view are to be aligned by viewing the direction indication B projected onto the projection-receiving object. The operator is thus less likely to load each article W in a wrong orientation, and can load the articles W still more efficiently.

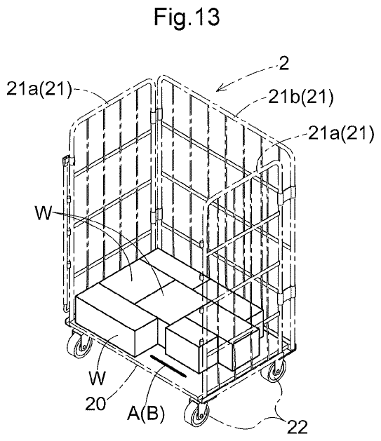

A linear image indicating the position to place the target article and the direction of the target article may be projected onto, for example, the upper surfaces of one or more articles W or the mount 20 of the cage cart 2 serving as the receiving surface for the target article as shown in, for example, FIG. 13. Such a linear image is, in other words, the position indication A of the position at which the target article is to be loaded, the direction indication B of the direction of the target article, or a linear image integrating the position indication A and the direction indication B. Such a linear image, which has a simple shape, may be suitable when, for example, a laser pointer or projection mapping is used as the projector 14.

In the present embodiment, the direction indication B and the position indication A may be separate from each other and represented separately, rather than being represented as a single image.

### 3. Third Embodiment

A work support system 1 according to a third embodiment will now be described with reference to FIG. 7. The present embodiment differs from the first embodiment in that the controller 13 causes, in addition to the position indication A, a next-position indication N to be projected onto the projection-receiving object in a manner different from the manner in which the position indication A is projected. The next-position indication N indicates the position at which a next target article is to be loaded. The next target article is an article W to be loaded subsequently to the target article. The work support system 1 according to the present embodiment will be described below focusing on the differences from the first embodiment. The components and the structures not described below are the same as those in the first embodiment.

In the present embodiment, the next-position indication N is represented, for example, in a shape, in a color, or with luminance different from that of the position indication A or with a combination of these. The next-position indication N is not limited to a single next-position indication N, and multiple next-position indications N assigned with numbers corresponding to a loading order, such as #1, #2, #3 ..., may be projected.

In this structure, the operator can determine, in advance, the position at which the next article W is to be loaded when loading multiple articles W onto a base. The operator can thus load the articles W more efficiently.

In this structure, the operator can exchange the loading order of the current target article and the next target article, and can thus work more flexibly.

### 4. Fourth Embodiment

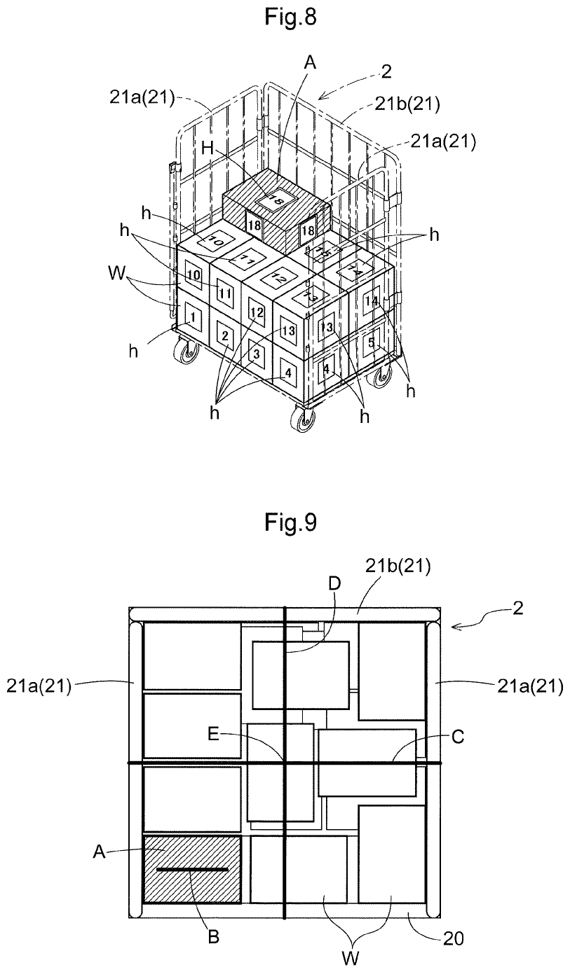

A work support system 1 according to a fourth embodiment will now be described with reference to FIG. 8. The present embodiment differs from the first embodiment in that the controller 13 causes at least one of an order indication H of the loading order of the target article among all the articles W to be loaded onto the base (cage cart 2) or order indications h of the loading order of one or more articles W, among all the articles W to be loaded onto the base (cage cart 2), already loaded to be projected onto the projection-receiving object. The work support system 1 according to the present embodiment will be described below focusing on the differences from the first embodiment. The components and the structures not described below are the same as those in the first embodiment.

Examples of the order indication H of the loading order of the target article and the order indications h of the loading order of one or more articles W already loaded include numbers indicating the loading order as shown in, for example, FIG. 8. Other examples of the order indications may include graphics such as bar graphs showing the position corresponding to the order of the target article among the articles W to be loaded.

The order indication H of the loading order of the target article and the position indication A may be represented as a single integrated image (e.g., a number is used in place of a colored line) as shown in FIG. 8. The order indication H and the position indication A may be represented as separate images.

### 5. Fifth Embodiment

A work support system 1 according to a fifth embodiment will now be described with reference to FIG. 9. The present embodiment differs from the first embodiment in that the controller 13 sets a reference point E on the receiving surface that is a surface of a base (cage cart 2) to receive multiple articles W and sets the X-axis and the Y-axis extending along a horizontal plane and intersecting with each other at the reference point E. In addition, the controller 13 causes a first reference line C overlapping the X-axis when viewed vertically and a second reference line D overlapping the Y-axis when viewed vertically to be projected across the base (cage cart 2) and one or more articles W already loaded on the base (cage cart 2). The work support system 1 according to the present embodiment will be described below focusing on the differences from the first embodiment. The components and the structures not described below are the same as those in the first embodiment.

In the present embodiment, the base (cage cart 2) is quadrangular (square or rectangular) in a plan view, the X-axis and the Y-axis are each set in a direction parallel to sides of the base (cage cart 2), and the intersection of the X-axis and the Y-axis (reference point E) is set at the center of the receiving surface (the centroid of the figure), as shown in, for example, FIG. 9. When one or more articles W are loaded on the base (cage cart 2), the X-axis, the Y-axis, and their intersection are projected onto the upper surfaces of the loaded articles W.

In the present embodiment, the reference point E may not be set at the center of the receiving surface. The reference point may be set at a position offset from the center of the receiving surface. The X-axis and the Y-axis may each be set in a direction intersecting with sides of the base (cage cart 2).

In the present embodiment, two reference lines referred to as the first reference line C and the second reference line D are used. However, the embodiments are not limited to this structure. In some embodiments, for example, additional reference lines each with, for example, a grid pattern or a radial pattern may be projected as a third reference line, a fourth reference line, ....

In this structure, the first reference line C and the second reference line D are projected onto the receiving surface of the base (cage cart 2) or the upper surfaces of one or more articles W already loaded on the receiving surface. The operator can thus load an article W using the reference lines as references. The operator can thus easily load an article W at an appropriate position.

### 6. Sixth Embodiment

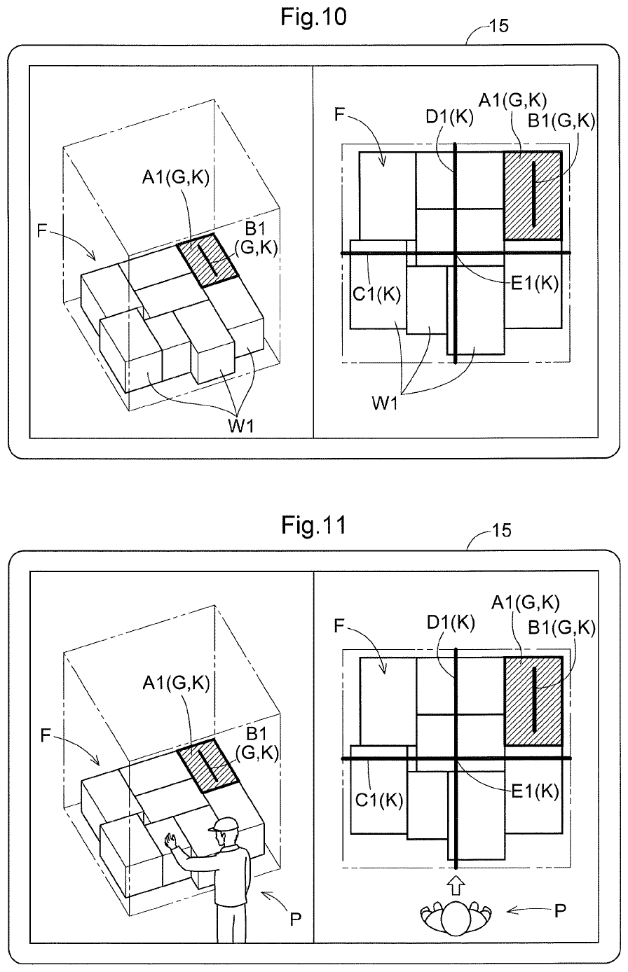

A work support system 1 according to a sixth embodiment will now be described with reference to FIG. 10. The present embodiment differs from the first embodiment in the two features described below. First, the present embodiment differs from the first embodiment in that the work support system 1 further includes an image display device 15 that displays an image on a display screen. In the present embodiment, the controller 13 causes the display screen to display a state display image F corresponding to one or more articles W already loaded on a base (cage cart 2) and a position image G indicating the position at which the target article is to be loaded. Second, the present embodiment differs from the first embodiment in that the work support system 1 displays, on the display screen, projection images K corresponding to projection on the projection-receiving object performed by the projector 14 in a manner in which the projection images K are superimposed on the state display image F. The work support system 1 according to the present embodiment will be described below focusing on the differences from the first embodiment. The components and the structures not described below are the same as those in the first embodiment or the other embodiments other than the first embodiment.

In the example shown in FIG. 10, projection images A1, B1, C1, D1, and El are displayed on the display screen as the projection images K each corresponding to the position indication A, the direction indication B, the first reference line C (X-axis), the second reference line D (Y-axis), or the intersection of the first reference line C and the second reference line D (reference point E) projected onto the projection-receiving object by the projector 14. The images with a reference numeral W1 correspond to the articles W.

In the present embodiment, the image display device 15 is, for example, a monitor or a projection display. For example, a three-dimensional image of the actual loading state is displayed on the display screen as the state display image F together with the position image G indicating the position at which the target article is to be loaded. Further, the projection images K corresponding to the projection on the projection-receiving object performed by the projector 14 are displayed on the display screen in a manner in which the projection images K are superimposed on the state display image F. The projection images K being displayed may correspond to part of the projection, not the entire projection. Images for the same purpose may be displayed in a manner different from the manner in which the projection appears. For example, the position indication A being projected may appear as red lines, and the corresponding projection image A1 may show an article W colored differently (e.g., red) from the other articles W (e.g., blue). An image of at least a portion of the base (cage cart 2), in addition to one or more loaded articles W, may further be displayed as the state display image F.

The projection images K may or may not include the position image G. The projection images K include the position image G when, for example, the position indication A and the direction indication B are projected onto the projection-receiving object as shown in FIG. 6 and the projection image A1 corresponding to the position indication A and the projection image B1 corresponding to the direction indication B are displayed on the display screen as projection images K as shown in FIG. 10. The projection images K include the position image G when, for example, the linear image shown in FIG. 13 is projected onto the projection-receiving object and an image corresponding to the linear image is displayed on the display screen as a projection image K. In contrast, the projection images K do not include the position image G when, for example, the projection image A1 corresponding to the position indication A is not displayed as a projection image K and the projection image B1 corresponding to the direction indication B is displayed on the display screen although the position indication A and the direction indication B are projected onto the projection-receiving object. The projection image B1 corresponding to the direction indication B may not be displayed and the projection image A1 corresponding to the position indication A may be displayed on the display screen as a projection image K when, for example, the position indication A and the direction indication B are projected onto the projection-receiving object. In this case, the projection images K include the position image G.

In this structure, the operator can easily identify, for example, the position to load the target article also by viewing the images displayed on the display screen, and can also easily identify the current state of one or more articles W already loaded on the base (cage cart 2). The operator can thus load the articles W still more efficiently.

In the present embodiment, as shown in FIG. 10, the controller 13 may control the image display device 15 to display, on the display screen, both a three-dimensional image (shown on the left in FIG. 10) representing the state display image F, the position image G, and the projection images A1 and B1 three-dimensionally and a planar image (shown on the right in FIG. 10) representing the state display image F, the position image G, and the projection images A1 and B1 in a plan view. The three-dimensional image may be rendered perspectively. In this case, the angle at which the three-dimensional image is displayed may be changed as appropriate for better viewability by an operation performed by the operator.

In this structure, the operator can more easily identify, for example, the position to load the target article as well as the current state of one or more articles W already loaded on the base (cage cart 2) by viewing the images displayed on the display screen.

In the present embodiment, the controller 13 may cause the position image G to be an image having a shape corresponding to the target article, and control the image display device 15 to display, on the display screen, images of one or more articles W already loaded on the base (cage cart 2) included in the state display image F and the position image G in different manners (e.g., shapes, colors, or luminance).

In this structure, the operator can more easily identify the position to load the target article by viewing the images displayed on the display screen. The operator can thus load the articles W more efficiently.

In the present embodiment, as shown in FIG. 11, the controller 13 may change the orientation in which the state display image F, the position image G, and the projection images K are displayed on the display screen in response to an instruction from the operator, and may also control the image display device 15 to display, on the display screen, an operator position image P indicating the position of the operator performing the loading.

This structure can change the orientation in which the images are displayed on the display screen as appropriate, and can thus display the images at an angle at which the images are easily viewed by the operator. When the orientation in which the images are displayed on the display screen is changed as described above, the position of the operator is still identifiable in the image displayed on the display screen.

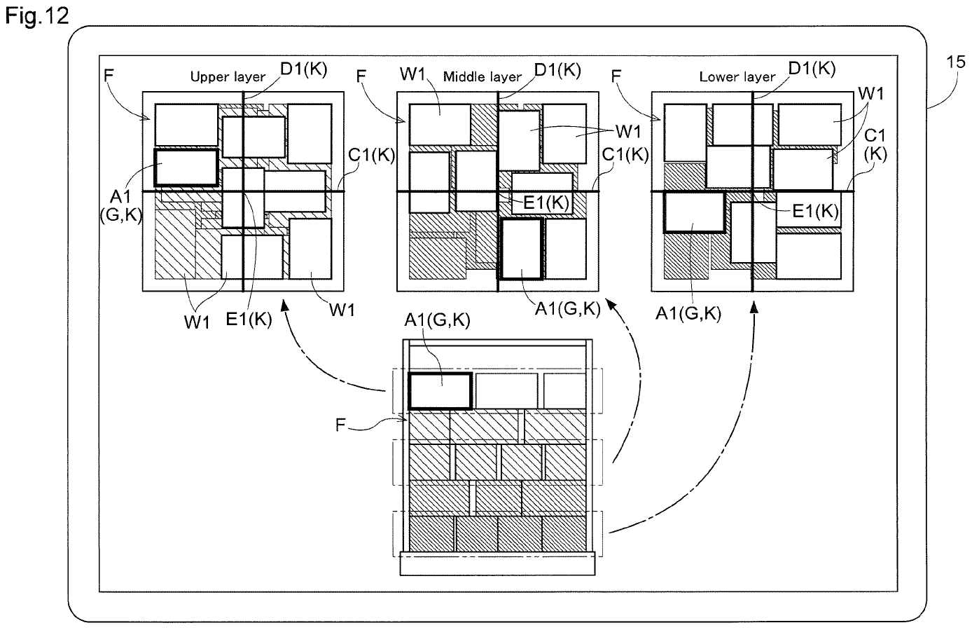

In the present embodiment, when articles W are to be loaded onto a base (cage cart 2) in multiple layers, the controller 13 may control the image display device 15 to display, on the display screen, an image of an article W included in the state display image F in a manner different based on, of the multiple layers, the layer including the article W as shown in FIG. 12. In the example shown in FIG. 12, both a side surface image (at the bottom in FIG. 12) and planar images (at the top in FIG. 12) are displayed on the display screen. The side surface image shows layers including the loaded articles W in a side view. The planar images show the respective layers in a plan view. These images are sequentially displayed layer by layer as the loading progresses. Of the layers of the loaded articles W, lower layers have darker gradations.

In this structure, the operator can intuitively identify the position to load the target article in the height direction by viewing the images displayed on the display screen. The operator can thus load the articles W more efficiently.

The structure described in each of the above embodiments may be combined with any other structures described in the other embodiments unless any contradiction arises. For other structures as well, the embodiments described herein are mere examples in all aspects. Thus, the embodiments may be modified variously as appropriate without departing from the spirit and scope of the disclosure.

### 7. Overview of Present Embodiment

An overview of the work support system according to the embodiments described above is provided below.

A work support system is a work support system for supporting, with an instruction to an operator, the operator in loading a plurality of articles onto a base for receiving the plurality of articles. The work support system includes a projector, and a controller that controls the projector, the controller being configured to cause the projector to project, onto a projection-receiving object, a position indication of a position at which a target article is to be loaded. The target article is an article, among the plurality of articles, to be loaded onto the base or onto an article, among the plurality of articles, loaded on the base. The projection-receiving object is at least one of the base or the article loaded on the base.

In this structure, the operator can easily identify the position to load the target article by viewing the position indication projected onto the projection-receiving object when loading multiple articles onto the base. The operator can thus load the articles more efficiently.

Each of the plurality of articles may be rectangular in a plan view, and the controller may cause the projector to project, in addition to or together with the position indication, a direction indication onto the projection-receiving object. The direction indication is an indication of a direction in which a long side of the target article in a plan view is to be aligned.

In this structure, when loading each article that is rectangular in a plan view, the operator can easily identify the direction in which the long sides of the article in a plan view are to be aligned by viewing the direction indication projected onto the projection-receiving object. The operator is thus less likely to load each article in a wrong orientation, and can load the articles still more efficiently.

The controller may cause the projector to project, in addition to the position indication, a next-position indication onto the projection-receiving object in a manner different from a manner in which the position indication is projected. The next-position indication is an indication of a position at which a next target article is to be loaded. The next target article is an article, among the plurality of articles, to be loaded subsequently to the target article.

In this structure, the operator can determine, in advance, the position at which the next article is to be loaded when loading multiple articles onto the base. The operator can thus load the articles more efficiently.

In this structure, the operator can exchange the loading order of the current target article and the next target article, and can thus work more flexibly.

The controller may cause the projector to project, onto the projection-receiving object, at least one of an order indication of a loading order of the target article among all the plurality of articles to be loaded onto the base, or an order indication of a loading order of an article loaded on the base among all the plurality of articles to be loaded onto the base.

In this structure, when loading multiple articles onto the base, the operator can easily determine at least one of the loading order of the current target article among all the articles to be loaded onto the base or the loading order of each of the articles already loaded.

The controller may set a reference point on a base surface being a surface of the base to receive the plurality of articles, set an X-axis and a Y-axis extending along horizontal planes and intersecting with each other at the reference point, and cause the projector to project, across the base and the article loaded on the base, a first reference line overlapping the X-axis when viewed vertically and a second reference line overlapping the Y-axis when viewed vertically.

In this structure, the first reference line and the second reference line are projected onto the receiving surface of the base or the upper surfaces of the articles already loaded on the receiving surface. The operator can thus load an article using the reference lines as references. The operator can thus easily load an article at an appropriate position.

The work support system may further include an image display device that displays an image on a display screen. The controller may cause the display screen to display a state display image corresponding to the article loaded on the base and a position image indicating the position at which the target article is to be loaded.

In this structure, the operator can easily identify, for example, the position to load the target article also by viewing the images displayed on the display screen, and can also easily identify the current state of the articles already loaded on the base. The operator can thus load the articles still more efficiently.

The work support system may cause the image display device to display, on the display screen, a projection image corresponding to projection on the projection-receiving object performed by the projector in a manner in which the projection image is superimposed on the state display image.

In this structure, the projection image corresponding to the projection on the projection-receiving object performed by the projector is also displayed on the display screen. The operator can thus identify the images projected onto the actual projection-receiving object by the projector and the projection images displayed on the display screen in a manner associated with each other. The operator can thus load the articles still more efficiently.

The controller may control the image display device to display, on the display screen, both a three-dimensional image representing the state display image, the position image, and the projection image three-dimensionally and a planar image representing the state display image, the position image, and the projection image in a plan view.

In this structure, the operator can more easily identify, for example, the position to load the target article as well as the current state of the articles already loaded on the base by viewing the images displayed on the display screen.

The controller may cause the position image to be an image having a shape corresponding to the target article, and cause the image display device to display, on the display screen, an image of the article loaded on the base included in the state display image and the position image in different manners.

In this structure, the operator can more easily identify the position to load the target article by viewing the images displayed on the display screen. The operator can thus load the articles more efficiently.

The controller may change an orientation in which the state display image, the position image, and the projection images are displayed on the display screen in response to an instruction from the operator, and control the image display device to display, on the display screen, an operator position image indicating a position of the operator performing the loading.

This structure can change the orientation in which the images are displayed on the display screen as appropriate, and can thus display the images at an angle at which the images are easily viewed by the operator. When the orientation in which the images are displayed on the display screen is changed as described above, the position of the operator is still identifiable in the image displayed on the display screen.

When the plurality of articles are to be loaded onto the base in a plurality of layers, the controller may control the image display device to display, on the display screen, an image of an article included in the state display image in a manner different based on, of the plurality of layers, a layer including the article.

In this structure, the operator can intuitively identify the position to load the target article in the height direction by viewing the images displayed on the display screen. The operator can thus load the articles more efficiently.

### INDUSTRIAL APPLICABILITY

The technique according to one or more embodiments of the present disclosure is applicable to loading multiple articles onto a base.

### REFERENCE SIGNS LIST

100 article transport facility
1 work support system
2 cage cart (base)
20 mount (receiving surface)
21 peripheral wall
21a side surface
21b back surface
22 wheel for mobility
3 infeeder
4 work area
5 transport conveyor
6 shipping area
7 labeling machine
8 shipping conveyor
9 storage
10 first outfeed conveyor
11 second outfeed conveyor
12 third outfeed conveyor
13 controller
14 projector
15 image display device
A position indication
B direction indication
C first reference line (X-axis)
D second reference line (Y-axis)
E intersection (reference point)
F state display image
G position image
H order indication of loading order of target article
h order indication of loading order of article already loaded
N next-position indication
P operator position image
W article
K projection image

1. A work support system for supporting, with an instruction to an operator, the operator in loading a plurality of articles onto a base for receiving the plurality of articles, the work support system comprising:
a projector; and
a controller configured to control the projector, and
wherein the controller is configured to cause the projector to project, onto a projection-receiving object, a position indication of a position at which a target article is to be loaded, the target article being an article, among the plurality of articles, to be loaded onto the base or onto an article, among the plurality of articles, loaded on the base, the projection-receiving object being at least one of the base or the article loaded on the base.

2. The work support system according to claim 1, wherein:
each of the plurality of articles is rectangular in a plan view, and
the controller causes the projector to project, in addition to or together with the position indication, a direction indication onto the projection-receiving object, and the direction indication is an indication of a direction in which a long side of the target article in a plan view is to be aligned.

3. The work support system according to claim 1, wherein:
the controller causes the projector to project, in addition to the position indication, a next-position indication onto the projection-receiving object in a manner different from a manner in which the position indication is projected, the next-position indication is an indication of a position at which a next target article is to be loaded, and the next target article is an article, among the plurality of articles, to be loaded subsequently to the target article.

4. The work support system according to claim 1, wherein:
the controller causes the projector to project, onto the projection-receiving object, at least one of an order indication of a loading order of the target article among all the plurality of articles to be loaded onto the base, or an order indication of a loading order of an article loaded on the base among all the plurality of articles to be loaded onto the base.

5. The work support system according to claim 1, wherein:
the controller causes the projector to project, onto the projection-receiving object, at least one of an order indication of a loading order of the target article among all the plurality of articles to be loaded onto the base, or an order indication of a loading order of an article loaded on the base among all the plurality of articles to be loaded onto the base.

6. The work support system according to claim 1, further comprising:
an image display device configured to display an image on a display screen, and
wherein the controller causes the display screen to display a state display image corresponding to the article loaded on the base and a position image indicating the position at which the target article is to be loaded.

7. The work support system according to claim 6, wherein:
the work support system causes the image display device to display, on the display screen, a projection image corresponding to projection on the projection-receiving object performed by the projector in a manner in which the projection image is superimposed on the state display image.

8. The work support system according to claim 7, wherein:
the controller causes the image display device to display, on the display screen, both a three-dimensional image representing the state display image, the position image, and the projection image three-dimensionally and a planar image representing the state display image, the position image, and the projection image in a plan view.

9. The work support system according to claim 6, wherein:
the controller causes the position image to be an image having a shape corresponding to the target article, and cause the image display device to display, on the display screen, an image of the article loaded on the base included in the state display image and the position image in different manners.

10. The work support system according to claim 7, wherein:
the controller changes an orientation in which the state display image, the position image, and the projection images are displayed on the display screen in response to an instruction from the operator, and controls the image display device to display, on the display screen, an operator position image indicating a position of the operator performing the loading.

11. The work support system according to claim 6, wherein:
when the plurality of articles are to be loaded onto the base in a plurality of layers, the controller causes the image display device to display, on the display screen, an image of an article included in the state display image in a manner different based on, of the plurality of layers, a layer including the article.
